(19) United States
(12) Patent Application Publication
(10) Pub. No.: US 2010/0256821 A1
(43) Pub. Date: Oct. 7, 2010

(54) CONSTANT AIRFLOW CONTROL OF A VENTILATION SYSTEM

(75) Inventors: Young Chun Jeung, Cypress, CA (US); Jin Ho Jung, Uiwang-si (KR)

Correspondence Address: KNOBBE MARTENS OLSON & BEAR LLP, 2040 MAIN STREET, FOURTEENTH FLOOR, IRVINE, CA, 92614, US

(73) Assignee: SNTECH INC., Phoenix, AZ (US)

(21) Appl. No.: 12/416,882

(22) Filed: Apr. 1, 2009

(51) Int. Cl. F24F 7/007; H02P 27/08; G05D 7/06; G06F 3/048; G05B 13/02

(52) U.S. Cl. 700/276; 454/338; 318/504; 715/772; 700/295

(57) ABSTRACT

A ventilation system for providing a substantially constant airflow is disclosed. In one embodiment, a ventilation system includes: a duct; a fan configured to generate an airflow through the duct; a motor configured to drive the fan; an electric current detector configured to detect an electric current provided to the motor and to generate a current feedback signal; a motor speed detector configured to detect a rotational speed of the motor and to generate a speed feedback signal; and a controller configured to determine in which speed range among a plurality of speed ranges the speed of the motor is, based at least partly on the speed feedback signal. The controller is further configured to change the electric current by a compensation amount pre-assigned to the determined speed range so as to reach a target value.

### CROSS-REFERENCE TO RELATED APPLICATIONS

This application is related to U.S. patent application Ser. No. ______ filed concurrently herewith (Attorney Docket No. SNTEC.018A2) and entitled “CALIBRATION OF MOTOR FOR CONSTANT AIRFLOW CONTROL,” which is hereby incorporated by reference herein.

### BACKGROUND OF THE INVENTION

1. Field of the Invention

The present disclosure relates to airflow control, and more particularly, to control of an electric motor for a substantially constant airflow.

2. Discussion of Related Technology

A typical ventilation system includes a fan blowing air and a ventilation duct to guide the air from the fan to a room or space to air condition. An electric motor is coupled to the fan and rotates the fan. Certain ventilation systems also include a controller or control circuit for controlling operation of the electric motor for adjusting the rotational speed of the motor. The controller may change the electric current supplied to the electric motor to adjust the rotational speed. In certain ventilation systems, the controller controls the operation of the motor to adjust the airflow rate of the duct. The term “airflow rate” refers to the volume of air flowing through a duct for a given time period.

### SUMMARY OF CERTAIN INVENTIVE ASPECTS

One aspect of the invention provides a ventilation system. The system comprises: a motor configured to drive a fan; a motor speed detector configured to detect a rotational speed of the motor; and a plurality of adjustment values stored in a memory, each of the adjustment values corresponding to one of a plurality of predetermined rotational speed ranges of the motor; wherein the ventilation system is configured to determine one of the predetermined rotational speed ranges in which the motor is running and to adjust an electric current supplied to the motor by one of the adjustment values corresponding to the determined one of the rotational speed ranges.

In the foregoing system, the adjustment values at their corresponding rotational speed ranges may be configured to achieve a substantially constant airflow operation of the ventilation system. The ventilation system may be configured to adjust the electric current by pulse width modulation. The plurality of predetermined rotational speed ranges may comprise a first range and a second range, the first range being lower than the second range, wherein the plurality of adjustment values comprise a first adjustment value corresponding to the first range, and a second adjustment value corresponding to the second range, and wherein the second adjustment value is greater than the first adjustment value in absolute value.

The system may further comprise an electric current detector configured to detect the electric current supplied to the motor. The system may further comprise a calibration device configured: to adjust the electric current supplied to the motor until a monitored airflow rate in the ventilation system reaches a target value, to determine a difference between values of the electric current before and after adjusting, and to cause to store, in the memory, the difference as an adjustment value corresponding to one of a plurality of predetermined rotational speed ranges of the motor.

The system may further comprise a user interface configured to allow a user to adjust the electric current via the calibration device. The system may be configured to run a substantially constant airflow operation without monitoring airflow rate changes. The system may be configured to run a substantially constant airflow operation without monitoring static pressure within a duct of the ventilation system.

The system may not comprise an airflow rate sensor that is connected to a controller of the motor. The system may not comprise a static pressure sensor that is connected to a controller of the motor.

Another aspect of the invention provides a method of calibrating a ventilation system. The method comprises: providing the foregoing ventilation system; driving the motor to generate an airflow through a duct of the ventilation system; monitoring a static pressure within the duct; determining that the static pressure is in one of a plurality of predetermined static pressure ranges; monitoring an airflow rate through the duct; adjusting the electric current supplied to the motor until the monitored airflow rate reaches a target value; determining a difference between values of the electric current before and after adjusting the electric current; and storing, in the memory, the difference as one of the adjustment values corresponding to a predetermined rotational speed range of the motor, which further corresponds to the determined static pressure range.

The method may further comprise: adjusting at least one opening of the duct so as to change the static pressure of the duct to be in another of the plurality of predetermined static pressure ranges; and repeating the steps of monitoring the airflow rate, adjusting the electric current, determining the difference, and storing the difference for the changed static pressure.

Yet another aspect of the invention provides a method of operating a ventilation system. The method comprises: providing the foregoing ventilation system; and running the motor, which comprises: detecting an electric current supplied to the motor, detecting a rotational speed of the motor using the motor speed detector, determining that the detected rotational speed is in one of the rotational speed ranges, retrieving one of the adjustment values that corresponds to the determined rotational speed range, and changing the electric current using the retrieved adjustment value.

In the method, changing the electric current may provide an airflow at a substantially constant airflow rate in the ventilation system. The method may further comprise calibrating prior to running the motor for the substantially constant airflow operation After calibrating, running of the motor may not need airflow rate information. After calibrating, running of the motor may not need static pressure information.

In the method, calibrating may comprise: driving the motor to generate an airflow through a duct of the ventilation system; monitoring a static pressure within the duct; determining that the static pressure is in one of a plurality of predetermined static pressure ranges; monitoring an airflow rate through the duct; adjusting the electric current supplied to the motor until the monitored airflow rate reaches a target value; determining a difference between values of the electric current before and after adjusting the electric current; and storing, in the memory, the difference as one of the adjustment values corresponding to a predetermined rotational speed range of the motor, which further corresponds to the determined static pressure range.

Calibrating may further comprise determining changing the electric current supplied to the motor; monitoring the rotational speed of the motor continuously or intermittently while changing the electric current; and determining at least one representative value of the electric current corresponding to each of a plurality of rotational speeds of the motor. In the method, running the motor may further comprise: receiving a desired airflow rate for operating the ventilation system, wherein the desired airflow rate is different from the target value; modifying the retrieved adjustment values, based at least partly on the determined relationship to obtain modified adjustment values; and changing the electric current using the modified adjustment values. Changing the electric current may comprise adjusting a turn-on period of the motor using pulse width modulation signals.

Yet another aspect of the invention provides a motor control circuit which comprises: an electric current detector configured to detect an electric current supplied to a motor; a motor speed detector configured to detect a rotational speed of the motor; and a plurality of adjustment values stored in a memory, each of the adjustment values corresponding to one of a plurality of predetermined rotational speed ranges of the motor, wherein the circuit is configured to determine one of the rotational speed ranges in which the motor is running and to adjust an electric current supplied to the motor by one of the adjustment values corresponding to the determined one of the rotational speed ranges.

In the circuit, the adjustment values at their corresponding rotational speed ranges may be configured to achieve a substantially constant airflow operation of the ventilation system. The circuit may be configured to adjust the electric current by pulse width modulation. The circuit may be configured to control the motor for a substantially constant airflow operation without an input of an airflow rate. The circuit may be configured to control the motor for a substantially constant airflow operation without an input of a static pressure.

Yet another aspect of the invention provides a calibration device for calibrating a motor of a ventilation system. The calibration device comprises: an adjusting module configured to adjust an electric current supplied to a motor until a monitored airflow rate reaches a target value; a determining module configured to determine a difference between values of the electric current before and after adjusting; and a communication module configured to communicate for causing to store, in a memory of the motor or its control circuit, the difference as one of adjustment values corresponding to one of a plurality of predetermined rotational speed ranges of the motor.

The calibration device may further comprise an airflow sensor configured to monitor an airflow rate through a duct of the ventilation system. The calibration device may be configured to receive the monitored airflow rate from the airflow sensor. The calibration device may further comprise a static pressure sensor configured to detect a static pressure within the duct, wherein each of the rotational speed ranges corresponds to one of a plurality of predetermined static pressure ranges. The calibration device may be configured to receive a detected static pressure from the static pressure senor and further configured to determine that the detected static pressure is one of the predetermined static pressure ranges.

The calibration device may further comprise a user interface configured to allow a user to adjust the electric current. The user interface may be further configured to allow the user to input either or both of a maximum airflow rate and a maximum speed of the motor. The calibration device may be further configured to generate calibration data, which the motor is configured to use for generating an airflow rate lower than the maximum airflow rate. The user interface may include a plurality of equalization bars, each corresponding to one of the plurality of predetermined rotational speed ranges, wherein each of the equalization bars is configured to allow adjustment of the electric current for each of the predetermined rotational speed ranges.

Another aspect of the invention provides a method of calibrating an electric motor in a ventilation system. The method comprises: providing a ventilation system comprising a duct, a motor, and a fan driven by the motor; providing the foregoing calibration device; driving the motor to generate an airflow through the duct; monitoring a static pressure within the duct using a static pressure sensor; determining that the static pressure is in one of a plurality of predetermined static pressure ranges; monitoring an airflow rate through the duct using an airflow sensor; adjusting the electric current supplied to the motor using the calibration device until the monitored airflow rate reaches a target value, wherein the calibration device determines a difference between values of the electric current before and after adjusting the electric current; and storing, in the memory, the difference as one of the adjustment values corresponding to a predetermined rotational speed range, which further corresponds to the determined static pressure range.

The method may further comprise: placing the airflow sensor within the duct prior to monitoring the airflow rate; and removing the airflow sensor from the duct after completing calibration of the motor. The method may further comprise: placing the static pressure sensor within the duct prior to monitoring the static pressure; and removing the static pressure sensor from the duct after completing calibration of the motor.

The foregoing method may further comprises: adjusting at least one opening of the duct so as to change the static pressure of the duct to be in another of the plurality of predetermined static pressure ranges; monitoring the airflow rate through the duct; adjusting the electric current supplied to the motor until the monitored airflow rate reaches the target value, wherein the calibration device determines a difference between values of the electric current before and after adjusting the electric current; and storing, in the memory, the difference as another of the adjustment values corresponding to another predetermined rotational speed range of the motor, which further corresponds to the other static pressure range.

The first one of the plurality of the static pressure ranges may be the highest range among the static pressure ranges, and the second one of the plurality of the static pressure ranges may be the second highest range among the static pressure ranges. The target airflow rate may be the maximum airflow rate that can be generated by the motor.

The method may further comprise determining another set of adjustment values for another target value, wherein determining the other set of adjustment values comprises: monitoring a static pressure within the duct using the static pressure sensor; determining that the static pressure is in the one of a plurality of predetermined static pressure ranges; monitoring an airflow rate through the duct using the airflow sensor; adjusting the electric current supplied to the motor using the calibration device until the monitored airflow rate reaches the other target value, wherein the calibration device determines a difference between values of the electric current before and after adjusting the electric current; and storing, in the memory, the difference as one of the other set of adjustment values corresponding to a predetermined rotational speed range, which further corresponds to the determined static pressure range.

The method may further comprise determining a correlation between the electric current and the rotational speed of the motor. Determining the relationship may comprise: changing the electric current provided to the motor; monitoring the rotational speed of the motor continuously or intermittently while changing the electric current; and determining at least one representative value of the electric current for each of a plurality of rotational speeds of the motor. The method may further comprise storing the determined correlation in the ventilation system. Adjusting the at least one opening may comprise adjusting a shutter provided to the at least one opening of the duct.

### BRIEF DESCRIPTION OF THE DRAWINGS

FIG. 1 is a schematic block diagram illustrating a ventilation system according to one embodiment.

FIG. 2 is a graph illustrating a relationship between static pressure and airflow rate in a ventilation system, showing constant air flow operations (vertical solid lines), constant torque operations (dotted lines), and motor speed against static pressure for a constant air flow operation (curved solid lines).

FIG. 3 is a graph illustrating relationships between static pressure and airflow rate in an ideal constant airflow operation (CA2) and in airflow operations (A1-A3) before torque compensation.

FIG. 4 is a graph illustrating relationships between static pressure and torque provided to the motor of a ventilation system in an ideal constant airflow operation (CA2) and in airflow operations (A1-A3) before torque compensation.

FIG. 5 is a graph illustrating a relationship between static pressure and the speed of the motor of a ventilation system in a constant airflow operation

FIG. 6A is a block diagram of a ventilation system including a controller according to one embodiment.

FIG. 6B is a block diagram of the controller of FIG. 6A.

FIGS. 7A-7C are timing diagrams illustrating a pulse width modulation scheme for adjusting torque to the motor of a ventilation system according to one embodiment.

FIG. 8 illustrates a user interface of the controller of FIG. 6B.

FIG. 9A is a blocking diagram illustrating a method of determining torque compensation amounts for the ventilation system of FIG. 6A.

FIG. 9B is a flowchart illustrating one embodiment of a method of determining torque compensation amounts for the ventilation system of FIG. 9A.

FIG. 10 is a flowchart illustrating one embodiment of a method of providing a constant air flow operation in a ventilation system.

FIG. 11 is a graph illustrating a relationship between static pressure and airflow rate resulting from a method of providing a constant air flow operation according to one embodiment.

### DETAILED DESCRIPTION OF CERTAIN INVENTIVE EMBODIMENTS

The following detailed description of certain embodiments presents various descriptions of specific embodiments of the invention. However, the invention can be embodied in a multitude of different ways as defined and covered by the claims. In this description, reference is made to the drawings where like reference numerals indicate identical or functionally similar elements.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described. Various processors, memories, computer readable media and programs can be used to implement the invention.

### Ventilation System With Motor Control System

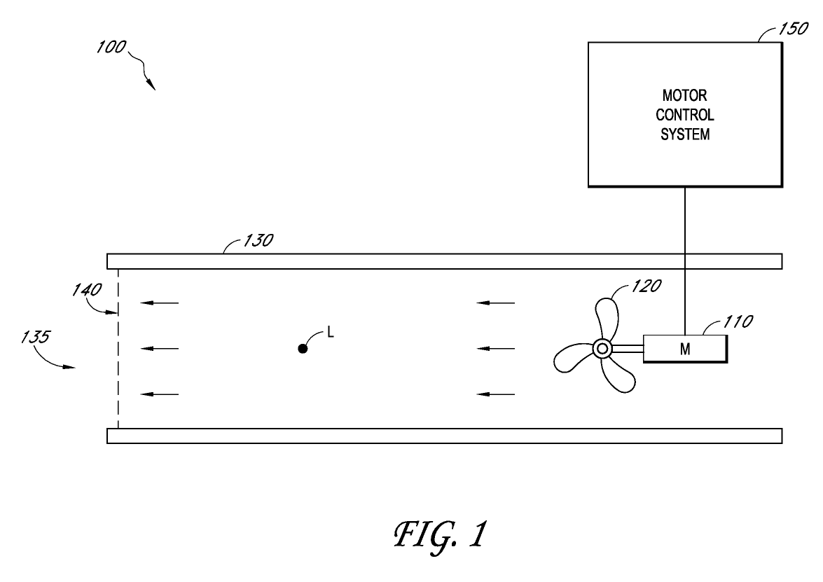

Referring to FIG. 1, a ventilation system according to one embodiment will be described below. The illustrated ventilation system 100 includes a motor 110, a fan 120 coupled to the motor 110, and a ventilation duct 130 to guide air blown by the fan 120. An air pressure inside the ventilation duct 130 may be represented by the pressure at a nominated location L inside the ventilation duct 130. In fluid dynamics, such an air pressure may be referred to as a “static pressure.” The static pressure inside the ventilation duct 130 may change for various reasons. The static pressure changes, for example, when an object is placed inside the duct 130 or in front of an opening 135 of the duct 130. Dust accumulated within the duct 130 or in a filter 140 installed in the duct 130 can increase the static pressure inside the duct 130. The static pressure changes make the airflow control difficult. In particular, the static pressure changes in the duct 130 influence the operation of the motor 110. In addition, the static pressure may differ from duct to duct, depending on various factors, including, but not limited to, the duct structure, motor power, and fan size and configuration.

In the illustrated embodiment, a motor control system 150 may be provided to control the operation of the motor 110. The motor control system 150 may adjust the airflow rate of the duct 130. More specifically, the motor control system 150 may be configured to control the operation of the motor 120 to generate a substantially constant airflow rate in the duct 130.

### Overview of Constant Airflow Operation

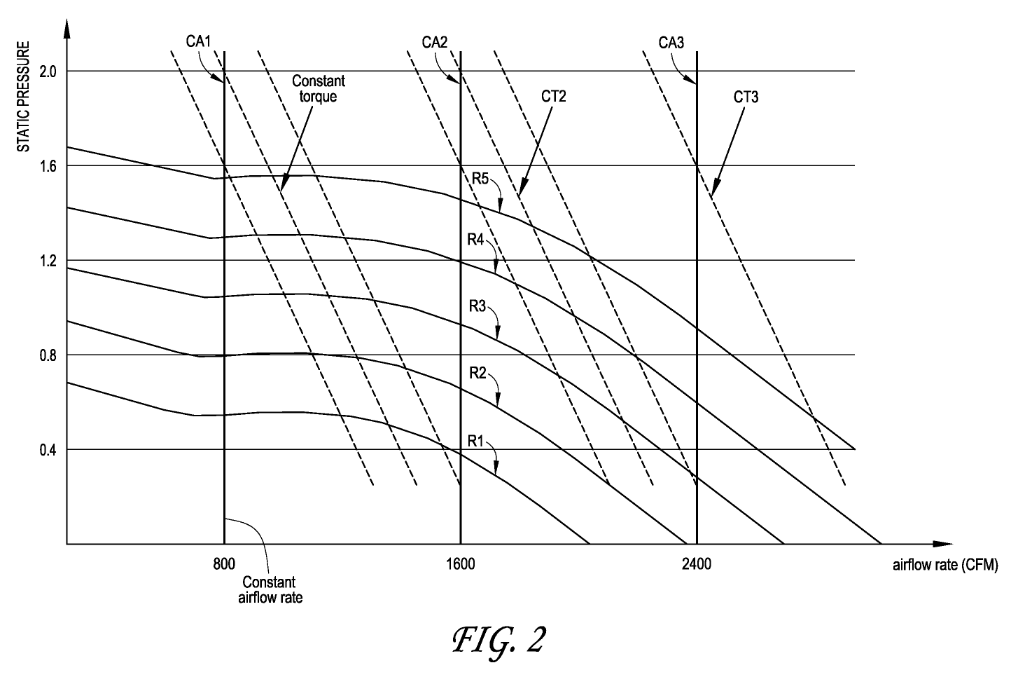

Referring to FIG. 2, relationships between static pressure and airflow rate will be described below. FIG. 2 plots changes of the airflow rate (volume/time) over changes of static pressure in a ventilation duct. The vertical solid lines CA1-CA3 represent ideal constant airflow operations. The sloped dotted lines CT1-CT3 represent operations with a constant motor torque. The curved solid lines R1-R5 represent operations with a constant motor speed.

In the ideal constant airflow operations, the airflow rate, e.g., in CFM (cubic feet per minute) stays constant over significant changes in the static pressure. In practice, the airflow rate stays substantially constant over changes in the static pressure. In some embodiments, the control system 150 attempts to control the motor's operation such that the airflow rate changes like the constant airflow operation lines CA1-CA3. In such embodiments, the airflow rate stays substantially constant for at least part of the span of static pressure changes or throughout the span of the static pressure changes.

In this document, the phrase “substantially constant airflow” means that the airflow rate remains within a range as the static pressure changes. According to various embodiments, a substantially constant airflow rate can stay within a range from a target airflow rate about 2, about 4, about 8, about 10, about 12, about 14, about 16, about 18, about 20, about 22, about 24, about 26, about 28 or about 30 percent of the total range in which the airflow rate can change when there is no airflow control. Alternatively, a substantially constant airflow rate can stay within a range from a target airflow range about 1, about 7, about 9, about 11, about 13, about 15, about 17, about 19, about 21, about 23, about 25, about 27 or about 29 percent of the range of the airflow rates between 0 CFM and the maximum airflow rate the motor can generate in a given ventilation system.

Referring again to FIG. 2, the lines CT1-CT3 representing constant motor torque operations have negative slopes, i.e., the airflow rate decreases as the static pressure increases. Thus, in order to provide a constant air flow operation, torque provided to the motor needs to be changed by a selected amount. Some conventional ventilation systems include an air pressure sensor at an opening of a duct or inside the duct to monitor the air pressure. The air pressure sensor monitors the change of the static pressure at its location, and provides a controller with an electrical feedback signal. The controller controls the amount of torque provided to the motor to maintain the static pressure within a certain range.

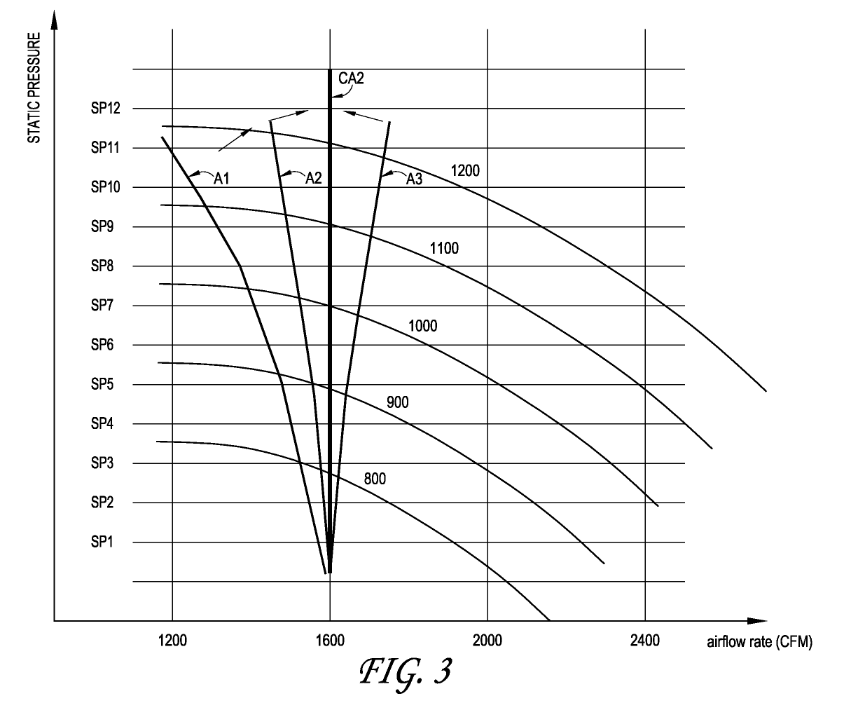

FIG. 3 illustrates static pressure-airflow rate relationships of three different ventilation systems: a first ventilation system A1, a second ventilation system A2, and a third ventilation system A3. Ventilation systems may have specific operational characteristics over changes of static pressure. In the illustrated example, the first ventilation system operates at a constant torque, and the second and third ventilation systems do not provide a constant torque operation. The flow rates of the second and third ventilation systems can vary due to certain factors, for example, the duct structure, motor power, and fan size and configuration. The straight line “CA2” in FIG. 3 represents a constant airflow operation at 1600 CFM.

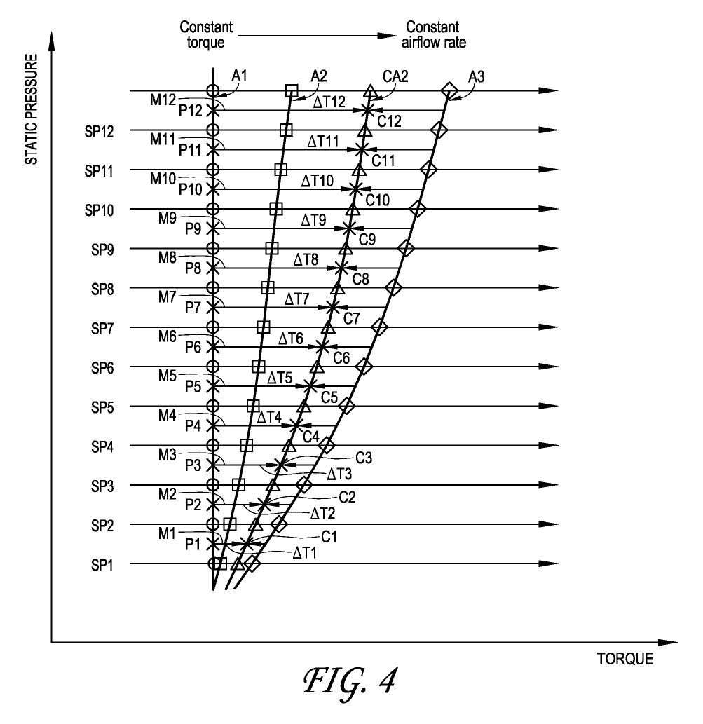

In embodiments, the torque of the motor is controlled or changed to provide a substantially constant air flow operation. Referring to FIG. 4, the control of motor torque is further discussed. More specifically, FIG. 4 illustrates the amount of torque to be changed to achieve a substantially constant airflow at given static pressures. In FIG. 4, the solid line CA2 represents a constant airflow operation. At a given static pressure, a horizontal distance from the constant air flow operation CA2 represents an amount of torque that needs to change to accomplish a substantially constant airflow operation. The operation of the first ventilation system is represented by the straight vertical line “A1.” In order to provide a substantially constant airflow operation, an amount of torque to be increased varies at different static pressures. For example, if the first ventilation system has a first static pressure P1, it needs to increase the torque by a first torque compensation amount ΔT1 to reach a first target point C1 on the constant airflow line CA2, as indicated by the arrow M1. If the first ventilation system has a second static pressure P2, it needs to increase the torque by a second torque compensation amount ΔT2 to reach a second target point C2, as indicated by the arrow M2. Likewise, if the first ventilation system has one of third to twelfth static pressures P3-P12, it needs to increase the torque by a respective one of third to twelfth torque compensation amounts ΔT3 to ΔT12 to reach a respective one of the target points C3-C12 on the constant airflow line CA2, as indicated by the arrows M3-M12. The torque compensation amounts ΔT1 to ΔT12 vary depending on the static pressure. In FIG. 4, the greater the static pressure is, the greater the torque compensation amount ΔTn is (n is an integer from 1 to 12). In this document, the term “compensation amount” can also be referred to as an “adjustment value.”

The operation of the second ventilation system is represented by a curved line “A2” between the line A2 and the line CA2. Similarly, torque compensation amounts for the second ventilation system vary depending on the static pressure. The operation of the third ventilation system is represented by a curved line “A3” on the right side of the line CA2. Similarly, torque compensation amounts for the third ventilation system vary depending on the static pressure, but the compensation amounts are negative (i.e., the torque is reduced to achieve a constant airflow operation). Similar to the first ventilation system, in the second and third ventilation systems, the greater the static pressure is, the greater the absolute value of the torque compensation amount is.

### Ventilation System for Constant Airflow Operation

In the ventilation system of FIG. 1, the motor control system 150 may monitor and utilize rotational speeds of the motor for the control of the airflow rate inside the duct. In addition, the motor control system may monitor and utilize an electric current provided to the motor for the control of the airflow rate. In certain embodiments, the motor control system 150 may process the values of the rotational speed and the electric current so as to determine the length of time during which the power to the motor is turned on (i.e., turn-on period) to accomplish a substantially constant airflow in the duct. In these embodiments, the controller system 150 controls the airflow rate using intrinsic information of the motor's operation, such as the rotational speed of the motor and electric current provided to the motor, rather than using extrinsic information such as static pressure and airflow rate.

In one embodiment, the motor control system 150 may not require an air (static) pressure sensor (or detector) for monitoring the static pressure changes. In addition, the motor control system 150 may not require a feedback control based on a monitored static pressure input. Furthermore, the control system 150 may not require an airflow rate sensor for monitoring the airflow rate changes or a feedback control based on a monitored airflow rate input. In some embodiments, the control system 150 is embedded in the motor, and in other embodiments the control system 150 is located outside the housing of the motor.

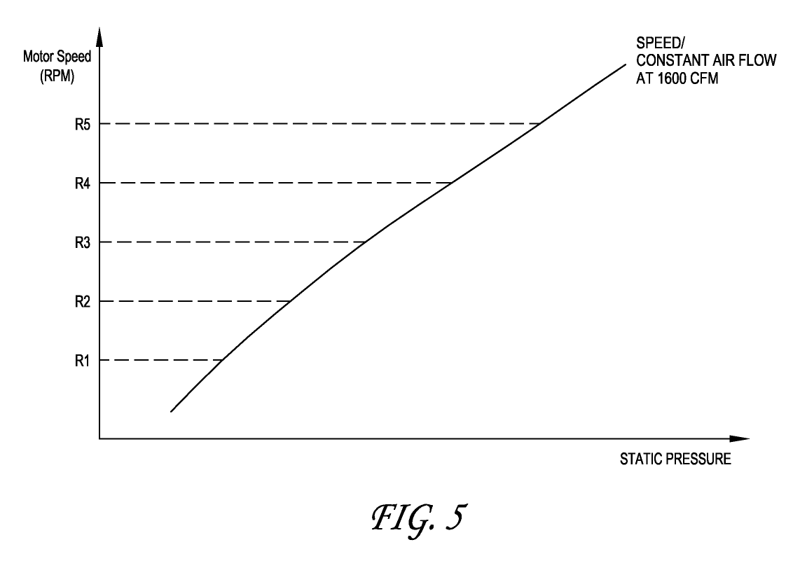

In a ventilation system providing a substantially constant airflow rate, the rotational speed (RPM) of its motor increases as the static pressure of the duct increases. Referring to FIG. 5, the rotational speed of the motor is substantially linearly proportional to the static pressure of the duct at a substantially constant airflow rate (for example, at 1600 CFM) when the rotational speed is within a certain range (see also curved solid lines R1-R5 in FIG. 2). Thus, the ventilation system may detect the rotational speed of the motor and utilize it in providing a constant air flow operation, instead of the static pressure.

In addition, as the electric current provided to the motor increases, an amount of torque provided to the motor increases. Thus, the ventilation system may detect the amount of electric current provided to the motor and utilize it in providing a constant air flow operation, instead of an amount of torque.

In certain embodiments, a ventilation system may have selected amounts of torque change assigned to a plurality of ranges of static pressure. In other words, torque changes are pre-selected or predetermined for various ranges of static pressure. Such selected amounts of torque change may be referred to as “torque compensation amounts” in this document. For example, a ventilation system has an N-number of ranges static pressures and an N-number of different torque compensation amounts are assigned to the N-number of ranges, respectively. The operational characteristics may result from various factors, for example, the types and configurations of the fan and motor, and the structure of the duct.

In embodiments, the ventilation system may detect the rotational speed of the motor rather than static pressure, as it is substantially proportional to the static pressure in a constant airflow operation. Further, in embodiments, the ventilation system may detect an electric current provided to the motor for the torque. In embodiments, the ventilation system may adjust the electric current to change the torque provided to the motor by the torque compensation amount assigned to the determined static pressure (rotational speed) if the amount of torque is not a target torque value for a substantially constant airflow operation. The torque provided to the motor can be repeatedly adjusted to achieve a substantially constant airflow operation.

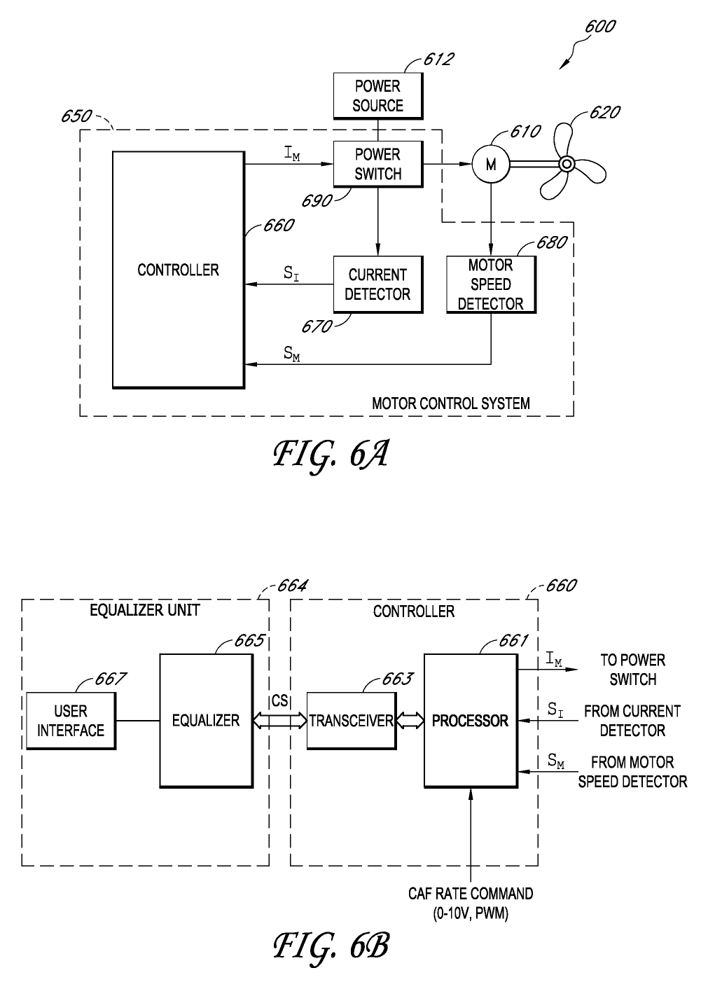

Referring to FIG. 6A, a ventilation system 600 of one embodiment includes a motor 610, a power source 612, a fan 620, and a motor control system 650. The ventilation system 600 also includes a duct (not shown) in which the fan is positioned. The motor 610 can be, for example, an electronically commutated motor, a brushless DC (BLDC) motor, or an electronically controlled DC motor. A skilled artisan will appreciate that any suitable types of motors can be adapted for the ventilation system 600. The power source 612 can be a DC power source. In other embodiments, the power source 612 can provide DC power converted from AC power of a commercial power supply. The power source 612 may include a battery or municipal power grid. In certain embodiments, the power source may include one or more solar panels or a wind-driven power source. The fan 620 can be, for example, a blower fan, and an axial fan. A skilled artisan will appreciate that any suitable types of fans can be adapted for the ventilation system 600.

The motor control system 650 may include a controller 660, a current detector 670, a motor speed detector 680, and a power switch 690. The controller 660 provides an electric current I_{M} to the power switch 690. The power switch 690 is electrically connected to the power source 612. The current detector 670 is electrically connected to the power switch 690 and provides a current feedback signal S_{I} to the controller 660. The motor speed detector 680 is electrically connect to the motor 610, and provides a speed feedback signal S_{M} to the controller 660.

The current detector 670 serves to detect a load current provided to the motor via the power switch 690. The load current may be a current flowing through the coil of the motor. The current detector 670 may detect the level of the current that varies over time. For example, the level of the current may be an average value for a time period, e.g., 3 milliseconds or 5 milliseconds. Examples of current detectors include, but are not limited to, a current transformer or a shunt resistor. A skilled artisan will appreciate that any suitable types of current detectors can be adapted for the ventilation system 600.

The motor speed detector 680 serves to detect the rotational speed (RPM or an equivalent) of the motor 610 while the ventilation system 600 is in operation. Examples of motor speed detectors include, but are not limited to, a Hall-effect sensor, an optical sensor, or a back (or counter) electromotive force (EMF) sensing circuit. A skilled artisan will appreciate that any suitable types of motor speed detectors can be adapted for the ventilation system 600.

Referring to FIG. 6B, the controller 660 according to one embodiment includes a processor 661 and a transceiver 663. An equalizer unit 664 according to the embodiment includes an equalizer 665 and a user interface 667. In certain embodiments, the transceiver 663 may be omitted, and the processor 661 can be directly connected to the equalizer 665. The processor 661 may be a microcontroller unit (MCU). The microcontroller may include a processor core, one or more memory devices (e.g., volatile and/or non-volatile memories), and programmable input/output peripherals. A skilled artisan will appreciate that any suitable types of MCUs can be adapted for the controller 660.

The processor 661 is configured to receive the current feedback signal S_{I} from the current detector 670, and the speed feedback signal S_{M} from the motor speed detector 680. The processor 661 is also configured to receive a control signal CS from the equalizer 665 via the transceiver 663. The processor 661 is further configured to receive a constant airflow rate command CAF RATE. The processor 661 is configured to provide the electric current I_{M} to the power switch 690.

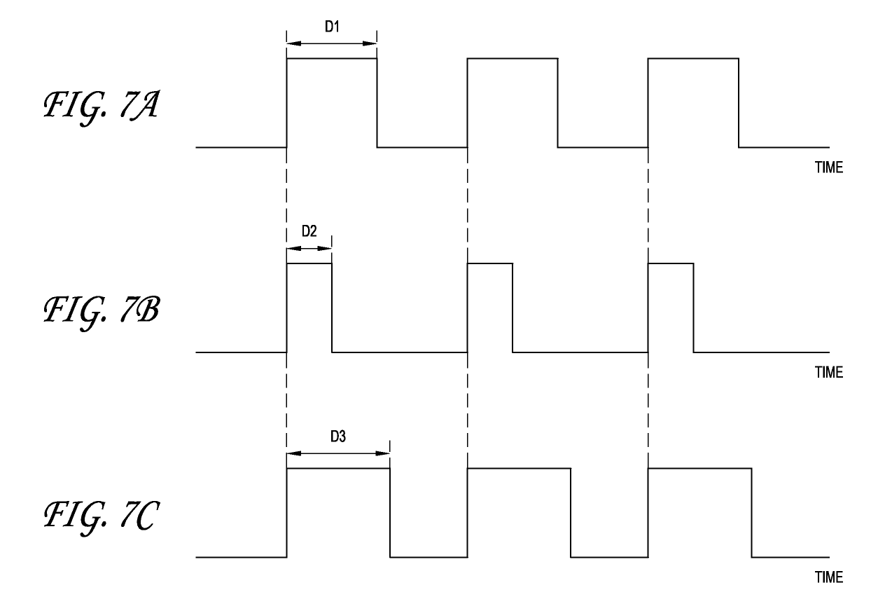

Referring to FIGS. 7A-7C, the electric current I_{M} provided to the power switch 690 (see FIGS. 6A and 6B) includes a series of pulses over time. In the illustrated embodiment, the pulses have a square or rectangular waveform having rising edges and falling edges. The electric current I_{M} repeats transitioning from a lower level to a higher level at a rising edge, and transitioning from the higher level to the lower level at an immediately next falling edge. A duration between a rising edge and an immediately next rising edge may be referred to as a cycle. In a cycle, a duration during which the electric current I_{M} is at the higher level is referred to as a duty cycle. The electric current I_{M}, when it is at the higher level (that is, during a duty cycle), provides electric power from the power source 612 to the motor 610 via the power switch 690, thereby providing torque to the motor 610 (see FIGS. 6A and 6B).

In the illustrated embodiment, the processor 661 may generate the electric current I_{M} by pulse width modulation (PWM). The processor 661 may provide the electric current I_{M} such that the pulses of the electric current I_{M} have a first (default) duty cycle D1 that provides a torque to maintain the rotational speed of the motor 610 substantially constant if the ventilation system is in a constant airflow operation. However, if there is a need for decreasing the torque to the motor, the processor 661 decreases the duty cycle of the pulses to a second duty cycle D2 (D1>D2), as shown in FIG. 7B. If there is a need for increasing the torque to the motor, the processor 661 increases the duty cycle of the pulses to a third duty cycle D3 (D3>D1), as shown in FIG. 7C. In other embodiments, the processor 661 may adjust the electric current, using any other suitable modulation scheme, for example, pulse amplitude modulation.

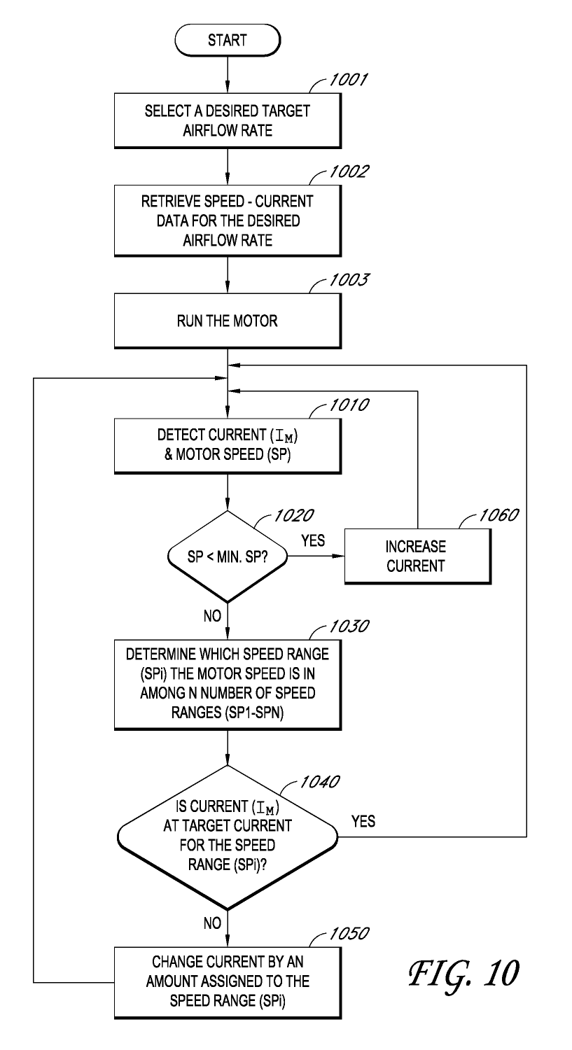

According to embodiments, the processor 661 adjusts the duty cycle of the pulses of the electric current I_{M}, based on a torque compensation amount assigned to the static pressure of the duct. The static pressure of the duct can be determined based on the speed feedback signal S_{M} from the motor speed detector 680. The operation of the processor 661 will be described below in detail with reference to FIG. 10.

In embodiments, the processor 661 adjusts the level of constant airflow according to a constant airflow rate command CAF RATE. The constant airflow rate command CAF RATE may be set by a user via the user interface 667 or another user interface (not shown) dedicated to input of the constant airflow rate command CAF RATE. The constant airflow rate command CAF RATE may be indicative of a value in a range between 0% and 100% of the maximum airflow rate that the motor can achieve. For example, if the maximum airflow rate is set to be 1000 CFM, and the constant airflow rate command CAF RATE is indicative of 50%, the processor 661 provides the electric current I_{M} such that the torque provided to the motor 610 can achieve about 500 CFM. The constant airflow rate command can be in the form of voltage (e.g., 0-10V) or a value for pulse width modulation (PWM).

The transceiver 663 provides a communication channel between the processor 661 and the equalizer 665. The communication channel may be a wired or wireless channel. In one embodiment, the transceiver 663 may include an RS 485 module for providing a wired communication channel. A skilled artisan will appreciate that any suitable types of communication channels may be provided between the processor 661 and the equalizer 665. In certain embodiments where the equalizer 665 is integrated with the processor 660, the transceiver may be omitted.

The equalizer 665 serves to provide torque compensation amounts to the processor 661. The equalizer 665 may provide different torque compensation amounts to different ranges of static pressure in the duct. The torque compensation amounts may be stored in the one or more memory devices of the processor 661.

The equalizer 665 may have an N-number of ranges of static pressure and an N-number of different torque compensation amounts corresponding to the N number of ranges, respectively, as in FIG. 4. In some embodiments, N can be any number from 2 to 1,000, for example, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, or 1000. In other embodiments, N can be greater than 1000. The greater the number of ranges, the greater the controllability of the equalizer 665 is.

In some embodiments, the equalizer 665 may be a unit separate from the processor 661. In such embodiments, it may be implemented in the form of a software program installed in a general purpose computer, including, but not limited to, a personal computer (a desktop or laptop computer). The equalizer 665 may include a communication module to allow the equalizer 665 to communicate with the processor 661 over a communication channel. In other embodiments, the equalizer 665 may be integrated with the processor 661.

The user interface 667 is to provide a user with access to the controller 660. The user interface 667 may be implemented on the housing of the motor or in a separate device such as a general purpose computer, including, but not limited to, a personal computer (a desktop or laptop computer). The computer may include a monitor, a keyboard, a mouse, and a computer body, and may run on any suitable operating system, e.g., Microsoft Window® or Linux®. In other embodiments, the user interface 667 may be a stand-alone user interface that includes a display device and an input pad. The stand-alone user interface may include a touch screen display device. The user interface 667 may be integrated with the equalizer 665.

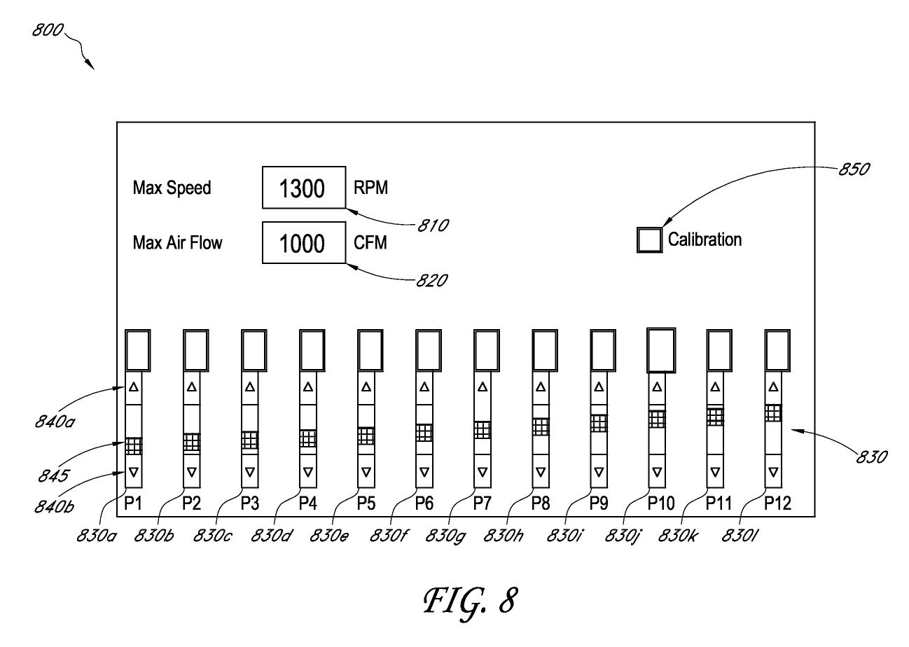

Referring to FIG. 8, one embodiment of the user interface 667 of FIG. 6B will be described below. FIG. 8 shows a screen 800 of a display device (e.g., a monitor or a touch screen display device) for providing access to the equalizer 665 of FIG. 6B. The screen 800 includes a maximum speed input box 810, a maximum airflow input box 820, equalization bars 830, and a calibration button 850.

The maximum speed input box 810 allows a user to input the maximum speed that can be provided by the motor 610. The maximum speed can be limited by the maximum capacity of the motor 610 controlled by the controller 660. The maxim airflow input box 820 allows the user to input a desired maximum airflow to be provided by the ventilation system.

The equalization bars 830 allow the user to manually adjust torque compensation amounts for static pressure ranges assigned by the equalizer 665 of FIG. 6B. In the illustrated embodiment, the equalizer 665 includes first to twelfth scroll bars 830a-830l to provide adjustment of torque compensation amounts for twelve static pressure ranges. Each of the scroll bars 830a-830l includes an up button 840a, a down button 840b, and a scroll button 845. The user may increase or decrease each of the torque compensation amounts for the static pressure ranges using the buttons 840a, 840b, 845.

In the illustrated embodiment, when any of the equalization bars 830a-830l has its scroll button 845 at a middle point, no torque compensation amount is provided to the processor 661 (FIG. 6B). If the scrolling button 845 is positioned below the middle point, a negative torque compensation amount is provided to the processor 661 (FIG. 6B) to decrease the torque to the motor 610. If the scrolling button 845 is positioned below the middle point, a positive torque compensation amount is provided to the processor 661 (FIG. 6B) to increase the torque to the motor 610. The user interface 667 may allow the user to change the number of equalization bars 830, depending on needs, to provide more or less refined control over the operation of the motor 610.

In other embodiments, the user interface 667 may include input boxes for inputting numbers or percentages, instead of such equalization bars. A skilled artisan will appreciate that various different schemes may be used for providing the equalizer 665 with the same function as described above in connection with FIG. 8.

The calibration button 850 allows the controller 660 of FIG. 6B to calibrate an amount of torque provided to the motor, depending on the airflow rate set for the ventilation system. When a user selects the calibration button 850, the equalizer 665 sends a control signal to the processor 661 such that the rotational speed of the motor 610 gradually increases from 0 rpm to the maximum speed provided in the maximum speed box 810. While the rotational speed increases, the processor 661 receives the current feedback signal S_{I} which is indicative of the torque provided to the motor 610. The equalizer 665 receives the current feedback signal S_{I} and the speed feedback signal S_{M}, and creates a database or a look-up table that includes data indicative of the relationship between electric current values and rotational speeds of the motor 610. The equalizer 665 provides the database to the processor 661, and the processor 661 may store it on its memory device for use during operation.

The database serves to provide an amount of torque required for generating an airflow rate different from the maximum airflow rate. During the operation of the ventilation system, a user may select an airflow rate using the constant airflow rate command CAF RATE. The user may select an airflow rate (e.g., about 10%, about 20%, about 30%, about 40%, about 50%, about 60%, about 70%, about 80%, about 90%, or about 100%) the same as or smaller than the maximum airflow rate. For example, the user may select 50% of the maximum airflow rate. An amount of torque that needs to be provided to the motor 610 to generate the selected airflow rate, however, may not be 50% of the amount of torque to generate the maximum airflow rate.

In such instances, the database allows the processor to calibrate amounts of torque for selected airflow rates. The rotational speed of a motor is generally proportional to an airflow rate generated by the motor. An electric current provided to a motor is generally proportional to an amount of torque provided to the motor. Thus, a relationship between the electric current and the rotational speed of the motor provides a relationship between the amount of torque and the airflow rate. The database provides the relationship between the electric current and the rotational speed of the motor. Thus, an electric current for generating a specific airflow rate can be calculated from the maximum airflow rate, based on the database.

### Initial Set-Up of Controller

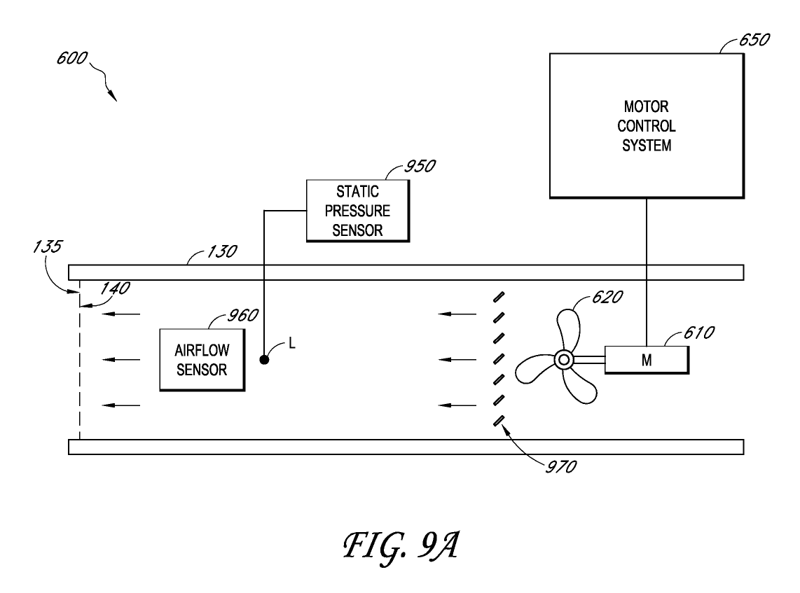

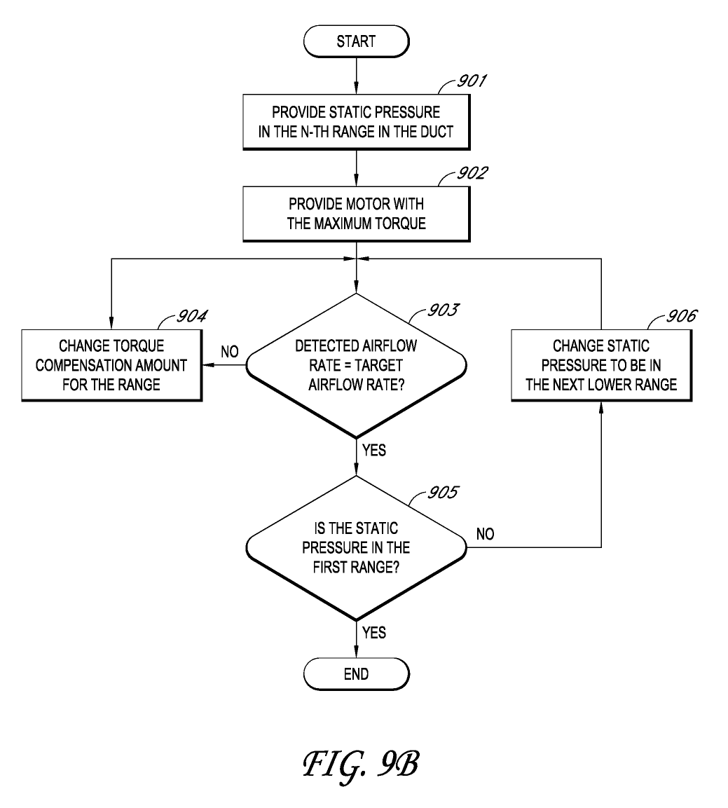

Referring to FIGS. 9A and 9B, a method of setting up the controller 660 of FIGS. 6A and 6B according to one embodiment will be described below. The method is provided to manually or automatically determine torque compensation amounts for the ventilation system 600 of FIG. 6A. This method may used when the controller 660 or motor 610 is first installed in the ventilation system 600.

Referring to FIG. 9A, the illustrated ventilation system 600 includes the motor 610, the fan 620 coupled to the motor 610, and the ventilation duct 130 to guide air blown by the fan 620. The duct 130 includes an opening 135 and a filter 135 installed at the opening 130. The duct 130 may also be provided with a shutter or damper 970 that allows control over an amount of airflow through the duct 130. The details of the foregoing components of the ventilation system 600 can be as described above in connection with FIGS. 1, 6A, 6B, 7A-7C, and 8.

A static pressure sensor 950 and an airflow rate sensor 960 are at least temporarily installed within the duct 130 or at appropriate locations to detect static pressure and airflow rate within the duct 130 for the method. The sensors 950, 960 can be removed after completing the method. The static pressure sensor 950 includes a probe inside the duct 130, and is configured to detect the static pressure at a point inside the duct 130. The airflow rate sensor 960 may be positioned inside the duct 130, and is configured to detect the airflow rate or amount of air flowing through the duct 130. The positions and configurations of the static pressure sensor 950 and the airflow rate sensor 960 may vary widely depending on the designs thereof and the duct configuration.

Referring to FIG. 9B, a user, a technician, or an installer may keep the shutter 970 closed but minimally open such that the static pressure is in its highest value in the N-th static pressure range of the N number of ranges (step 901). The motor 610 is provided with the maximum torque to provide the maximum motor speed (step 902). The user may monitor the airflow rate sensor 960 to see if it indicates a selected target airflow rate (for example, 1200 CFM) (step 903). If the airflow rate sensor 960 indicates a value deviating from the selected airflow rate, the user may change a torque compensation amount using the buttons 840a, 840b, 845 of the first scroll bar 830a for the first static pressure range on the user interface 667 (step 904). The user adjusts the torque compensation amount until the airflow rate sensor 960 indicates the selected airflow rate by repeating the steps 903 and 904.

Subsequently, it is determined if the current static pressure is in the first range among the N-th range at step 905. If yes, the set-up process is terminated. If no, the user opens the shutter 970 slightly more such that the static pressure is in the second highest static pressure range (a range immediately below the N-th range) of the N number of ranges (step 906). The user then monitors the airflow rate sensor 960 to see if it indicates the selected airflow rate (for example, 1200 CFM) (step 903). If the airflow sensor 960 indicates a value deviating from the selected airflow rate, the user sets or changes a torque compensation amount using the buttons 840a, 840b, 845 for the second scroll bar 830b for the second static pressure range on the user interface 667 (step 904). The user adjusts the torque compensation amount until the airflow rate sensor 960 indicates the selected airflow rate by repeating the steps 903 and 904. The user may repeat these steps for the remainder of the N number of static pressure ranges.

In the illustrated embodiment, the set-up process is conducted only for the selected target airflow rate. The selected target airflow rate can be the maximum airflow rate that can be provided by the motor 610. The maximum airflow rate refers to an air flow rate that is generated by a motor driving a fan in a duct when the motor operates at its maximum capacity.

During the operation of the motor 610, an operation at an airflow rate smaller than the maximum airflow rate can be performed using the CAF RATE command. In such an instance, the current provided to the motor 610 can be calibrated, based on the data stored in the database or look-up table described above in connection with the calibration button 850 of FIG. 8. In other embodiments, the set-up process may be repeated to obtain data for two or more airflow rates, and during operation, the data can be used for providing operations at the airflow rates.

After determining all the torque compensation amounts for the N number of static pressure ranges for the maximum airflow rate, the equalizer 665 provides the torque compensation amounts to the processor 661. The processor 661 may store the amounts in its memory. Then, the equalizer 665 and the user interface 667 may be removed from the controller 660. In other embodiments, the equalizer 665 and the user interface 667 may remain in the controller 660, depending on the needs.

In some embodiments, the method described above for determining torque compensation amounts may be automated. In such embodiments, the static pressure sensor 950 and the airflow sensor 960 may be electrically connected to the motor control system 650 to provide feedback signals to the motor control system 650. The motor control system 650 may control the operation of the shutter 970. In other embodiments, the shutter 970 may be manually controlled. The equalizer 665 of the motor control system 650 may receive the feedback signals from the static pressure sensor 950 and the airflow sensor 960, and adjust torque compensation amounts for the N number of static pressure ranges, based on the feedback signals, while adjusting the airflow rate, controlling the opening of the shutter 970. A skilled artisan will appreciate that the equalizer 665 may perform any suitable automation process for determining torque compensation amounts as in the manual process described above.

### Operation of Ventilation System

Referring to FIGS. 6A, 6B, and 10, one embodiment of a process of operating the ventilation system of FIGS. 6A and 6B will be described below. During the operation of the ventilation system 600, the motor control system 650 may perform steps described below.

At step 1001, a user selects a desired target airflow rate, using, for example, the CAF RATE command, as shown in FIG. 6B. Then, the controller retrieves motor speed-current data for the desired airflow rate at step 1002. The data may have been stored in the database or look-up table, as described above in connection with the calibration button 850 of FIG. 8.

Subsequently, the motor 610 is turned on and is run at step 1003. When the motor 610 is turned on, the current detector 670 and the motor speed detector 680 detect the current I_{M} provided to the motor 610 and the rotational speed (SP) of the motor 610, respectively, at step 1010. The processor 661 determines if the speed of the motor 610 is below a selected minimum speed at step 1020. If yes, the processor 661 increases the current I_{M} to increase an amount of torque provided to the motor 610. In the illustrated embodiment where pulse width modulation is used, the amount of torque is changed by adjusting the pulse width (or duty cycle) of the current I_{M}. Thus, the pulse width of the current I_{M} is increased at step 1060.

If the speed of the motor 610 is not below the selected minimum speed at step 1020, the processor 661 determines which speed range (SPi) the speed of the motor 610 is in among N number of speed ranges (SP1-SPN) at step 1030. Then, the processor 661 determines if the current I_{M} is at target current assigned for the speed range at step 1040. If “YES,” the process goes back to the step 1010.

If “NO” at step 1040, the processor 661 changes the current I_{M} to adjust the amount of torque provided to the motor 610. The processor 661 may change the current I_{M} so as to change the torque by a torque compensation amount assigned to the speed range determined at step 1030. The torque compensation amount has been determined during the set-up process described above in connection with FIG. 9. Then, the process goes back to the step 1010.

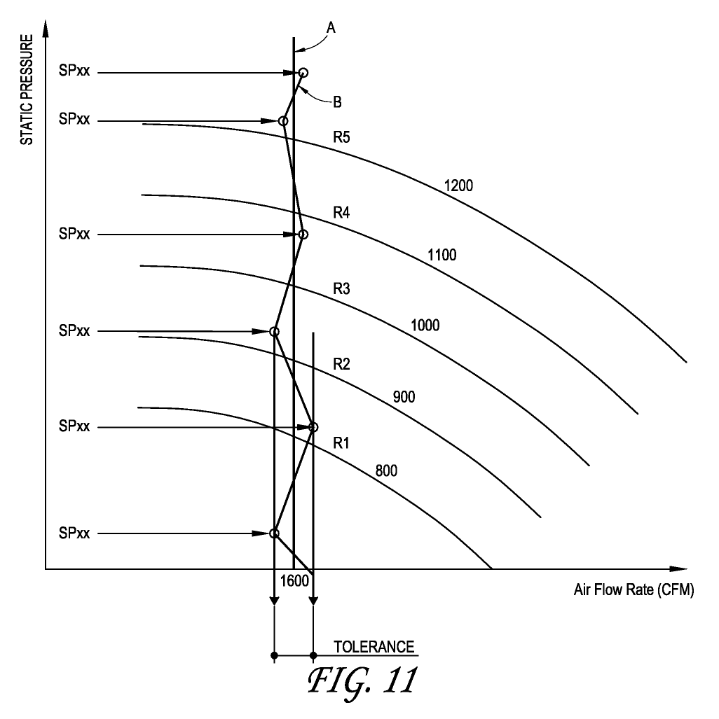

Referring to FIG. 11, the operational characteristics of the ventilation system 600 of FIGS. 6A and 6B will be described below. In FIG. 11, an ideal constant airflow (1600 CFM) is represented by the vertical straight line A. A controlled airflow rate generated by the ventilation system 600 is represented by the zigzagged line B.

During the operation of the ventilation system 600, when the current I_{M} (which represents torque to the motor) deviates from a target current assigned to a specific speed range (which represents static pressure inside the duct), the current I_{M} is changed by an amount assigned to the specific range. This, however, may not adjust the current I_{M} to reach the target current. Thus, the ventilation system 600 keeps adjusting the current I_{M} based on the feedback signals from the current detector 670 and the motor speed detector 680 such that the current I_{M} is within a selected tolerance. This operation results in the zigzagged line B in FIG. 11.

The ventilation system of the embodiments described above can provide a substantially constant airflow operation relatively effectively and accurately. The ventilation system may also provide a substantially constant airflow operation using a processor having a relatively small capacity. In addition, the ventilation system may not require an airflow rate sensor or a static pressure sensor during the operation thereof.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A ventilation system comprising:
a motor configured to drive a fan;
a motor speed detector configured to detect a rotational speed of the motor; and
a plurality of adjustment values stored in a memory, each of the adjustment values corresponding to one of a plurality of predetermined rotational speed ranges of the motor;
wherein the ventilation system is configured to determine one of the predetermined rotational speed ranges in which the motor is running and to adjust an electric current supplied to the motor by one of the adjustment values corresponding to the determined one of the rotational speed ranges.

2. The system of claim 1, wherein the adjustment values at their corresponding rotational speed ranges are configured to achieve a substantially constant airflow operation of the ventilation system.

3. The system of claim 1, wherein the ventilation system is configured to adjust the electric current by pulse width modulation.

4. The system of claim 1, wherein the plurality of predetermined rotational speed ranges comprise a first range and a second range, the first range being lower than the second range, wherein the plurality of adjustment values comprise a first adjustment value corresponding to the first range, and a second adjustment value corresponding to the second range, and wherein the second adjustment value is greater than the first adjustment value in absolute value.

5. The system of claim 1, further comprising an electric current detector configured to detect the electric current supplied to the motor.

6. The system of claim 1, further comprising a calibration device configured:
to adjust the electric current supplied to the motor until a monitored airflow rate in the ventilation system reaches a target value,
to determine a difference between values of the electric current before and after adjusting, and
to cause to store, in the memory, the difference as an adjustment value corresponding to one of a plurality of predetermined rotational speed ranges of the motor.

7. The system of claim 6, further comprising a user interface configured to allow a user to adjust the electric current via the calibration device.

8. The system of claim 1, wherein the system is configured to run a substantially constant airflow operation without monitoring airflow rate changes.

9. The system of claim 1, wherein the system is configured to run a substantially constant airflow operation without monitoring static pressure within a duct of the ventilation system.

10. The system of claim 1, wherein the system does not comprise an airflow rate sensor that is connected to a controller of the motor.

11. The system of claim 1, wherein the system does not comprise a static pressure sensor that is connected to a controller of the motor.

12. A method of calibrating a ventilation system, the method comprising:
providing the ventilation system of claim 1;
driving the motor to generate an airflow through a duct of the ventilation system;
monitoring a static pressure within the duct;
determining that the static pressure is in one of a plurality of predetermined static pressure ranges;
monitoring an airflow rate through the duct;
adjusting the electric current supplied to the motor until the monitored airflow rate reaches a target value;
determining a difference between values of the electric current before and after adjusting the electric current; and
storing, in the memory, the difference as one of the adjustment values corresponding to a predetermined rotational speed range of the motor, which further corresponds to the determined static pressure range.

13. The method of claim 12, further comprising:
adjusting at least one opening of the duct so as to change the static pressure of the duct to be in another of the plurality of predetermined static pressure ranges; and
repeating the steps of monitoring the airflow rate, adjusting the electric current, determining the difference, and storing the difference for the changed static pressure.

14. A method of operating a ventilation system, the method comprising:
providing the ventilation system of claim 1; and
running the motor, which comprises:
detecting an electric current supplied to the motor,
detecting a rotational speed of the motor using the motor speed detector,
determining that the detected rotational speed is in one of the rotational speed ranges,
retrieving one of the adjustment values that corresponds to the determined rotational speed range, and
changing the electric current using the retrieved adjustment value.

15. The method of claim 14, wherein changing the electric current provides an airflow at a substantially constant airflow rate in the ventilation system.

16. The method of claim 14, further comprising calibrating prior to running the motor for the substantially constant airflow operation.

17. The method of claim 16, wherein after calibrating, running of the motor does not need airflow rate information.

18. The method of claim 16, wherein after calibrating, running of the motor does not need static pressure information.

19. The method of claim 16, wherein calibrating comprises:
driving the motor to generate an airflow through a duct of the ventilation system;
monitoring a static pressure within the duct;
determining that the static pressure is in one of a plurality of predetermined static pressure ranges;
monitoring an airflow rate through the duct;
adjusting the electric current supplied to the motor until the monitored airflow rate reaches a target value;
determining a difference between values of the electric current before and after adjusting the electric current; and
storing, in the memory, the difference as one of the adjustment values corresponding to a predetermined rotational speed range of the motor, which further corresponds to the determined static pressure range.

20. The method of claim 19, wherein calibrating further comprises determining a relationship between the electric current and the rotational speed of the motor, and wherein determining the relationship comprises:
changing the electric current supplied to the motor;
monitoring the rotational speed of the motor continuously or intermittently while changing the electric current; and
determining at least one representative value of the electric current corresponding to each of a plurality of rotational speeds of the motor.

21. The method of claim 20, wherein running the motor further comprises:
receiving a desired airflow rate for operating the ventilation system, wherein the desired airflow rate is different from the target value;
modifying the retrieved adjustment values, based at least partly on the determined relationship to obtain modified adjustment values; and
changing the electric current using the modified adjustment values.

22. The method of claim 14, wherein changing the electric current comprises adjusting a turn-on period of the motor using pulse width modulation signals.

23. A motor control circuit comprising:
an electric current detector configured to detect an electric current supplied to a motor;
a motor speed detector configured to detect a rotational speed of the motor; and
a plurality of adjustment values stored in a memory, each of the adjustment values corresponding to one of a plurality of predetermined rotational speed ranges of the motor,
wherein the circuit is configured to determine one of the rotational speed ranges in which the motor is running and to adjust an electric current supplied to the motor by one of the adjustment values corresponding to the determined one of the rotational speed ranges.

24. The circuit of claim 23, wherein the adjustment values at their corresponding rotational speed ranges are configured to achieve a substantially constant airflow operation of the ventilation system.

25. The circuit of claim 23, wherein the circuit is configured to adjust the electric current by pulse width modulation.

26. The circuit of claim 23, wherein the circuit is configured to control the motor for a substantially constant airflow operation without an input of an airflow rate.

27. The circuit of claim 23, wherein the circuit is configured to control the motor for a substantially constant airflow operation without an input of a static pressure.
